(19) United States
(12) Patent Application Publication
(10) Pub. No.: US 2007/0055941 A1
(43) Pub. Date: Mar. 8, 2007

(54) Method and apparatus to selectively display portions of a shared desktop in a collaborative environment

(76) Inventors: Dharmesh N. Bhakta, Austin, TX (US); Trung Q. Ly, Austin, TX (US); Juan F. Obas, Austin, TX (US); Lakshmi N. Potluri, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/221,550

(22) Filed: Sep. 8, 2005

(51) Int. Cl. G06F 9/00

(52) U.S. Cl. 715/739

(57) ABSTRACT

Methods and systems for selectively displaying a portion of an electronic desktop to a remote display are provided. A user interface such as a mouse or touchpad is used to select a region on the electronic desktop of a first computer to be displayed remotely. A signal including the content displayed in the region is sent to a second computer for remotely displaying the defined portion of the first computer's electronic desktop.

### FIELD OF THE INVENTION

The present invention relates generally to systems and methods for manipulating and/or displaying selected portions of shared electronic visual regions. More specifically the present invention relates to displaying selected portions of an electronic desktop to remote monitors.

### BACKGROUND OF THE INVENTION

During an electronic conference or presentation often a presenter (host) would like to have the option to obscure or show a portion of presentation to observers (clients). Current systems allow the display of the presenter's electronic desktop, but not the selective displaying of portions or multiple applications of the electronic desktop to the observers. An electronic desktop, for example, may be displayed on the monitor or screen of an electronic device such as a computer. Examples of electronic desktops include graphical user interface (GUI) based operating systems (OS) displays for computers, personal digital assistants (PDA), cellular telephones or other such electronic devices with display capabilities known to those of ordinary skill in the art.

FIG. 1 illustrates a conventional system of shared electronic visual regions. In the example shown an operator 40, interacts with a computer system to generate a primary display 10, which in this example contains two separate regions (e.g. associated with software systems), Display Region 20, and Display region 30. A projector 50 projects the primary display 10 to a projected display region 70, wherein the display region 20 is projected as projected display region 80, and wherein display region 30 is projected as projected display region 90. Additionally the shared electronic visual regions can be displayed on computers of conference/presentation attendees 95. In conventional systems both displays regions 20 and 30 are remotely displayed, whether desired or not.

### SUMMARY OF THE INVENTION

Various exemplary embodiments are drawn to systems and methods of display selectivity. These include providing an electronic desktop, where the electronic desktop includes a first portion and a second portion. The first portion of the electronic desktop is selected, wherein the contents of the first portion include at least an application and/or a display within the first portion. A determination is made for the content, the send content, which is to be sent to a remote monitor. The send content may be the contents of the first portion and/or the remaining contents of the electronic desktop, wherein the remaining contents of the electronic desktop are defined as the contents of the electronic desktop minus the contents of the first portion. The send content is sent to a remote monitor.

At least one exemplary embodiment provides for a system of selective display, which includes an electronic desktop, a user interface configured to assist the user in selecting at least one content, a send content which is a portion of the electronic desktop, and a processing unit, wherein the processing unit is configured to accept the send content and is configured to send the send content to a remote monitor.

At least one exemplary embodiment provides for a computer program embodied on a computer-readable medium which includes source code for identifying a region in an electronic desktop, source code relating the electronic desktop to a first stored data region on a data storage medium, source code for relating the identified region to a second data region on the data storage medium, and source code for sending the contents of the region to a remote monitor. Additional exemplary embodiments provide source code for sending the contents of the identified region to a processor, wherein the processor sends the contents of the electronic desktop to a video adapter.

Further areas of applicability of embodiments of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

Embodiments of present invention will become more fully understood from the detailed description and the accompanying drawings, wherein:

FIG. 1 illustrates a conventional system of presentation;

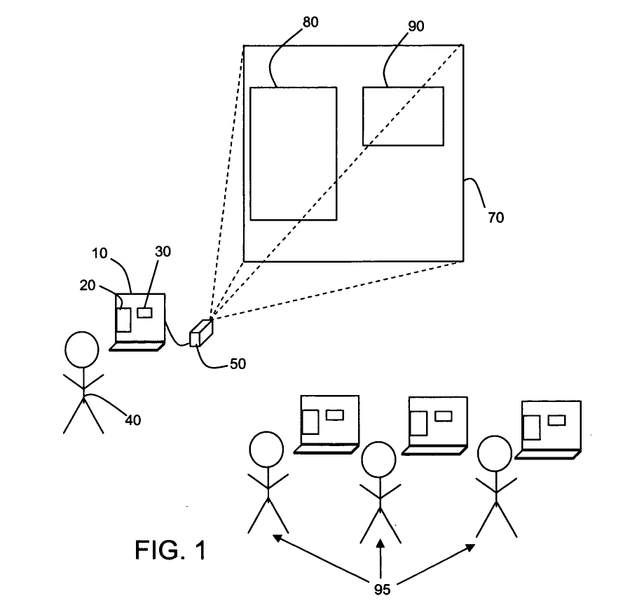

FIGS. 2A-2I illustrate methods and systems for displaying selected portions of an electronic desktop in accordance with at least one exemplary embodiment;

FIG. 3 illustrates an electronic desktop hardware support system in accordance with at least one exemplary embodiment;

FIG. 4 illustrates the internal structure of an electronic desktop hardware support system in accordance with at least one exemplary embodiment;

FIG. 5 illustrates a flowchart of a method for displaying selected portions of an electronic desktop in accordance with at least one exemplary embodiment;

FIG. 6 illustrates a host primary display in accordance with at least one exemplary embodiment; and

FIG. 7 illustrates a client display related to the host primary display of FIG. 6, in accordance with at least one exemplary embodiment.

### DETAILED DESCRIPTION

The following description of the various exemplary embodiments is illustrative in nature and is not intended to limit the invention, its application, or uses.

Various exemplary embodiments provide methods and/or systems for display selectivity. In at least one exemplary embodiment an electronic desktop is provided, which may display various applications and display portion. An application, as used herein, is a program, routine or other logic running on an electronic device which displays an output or result on the electronic desktop. For example, most Windows™ or GUI-based programs display a result or output on an electronic desktop (e.g., MS Word™, PowerPoint™, Adobe Acrobat™, or the like). A user can select a portion of the electronic desktop to be displayed or not displayed on a remote monitor.

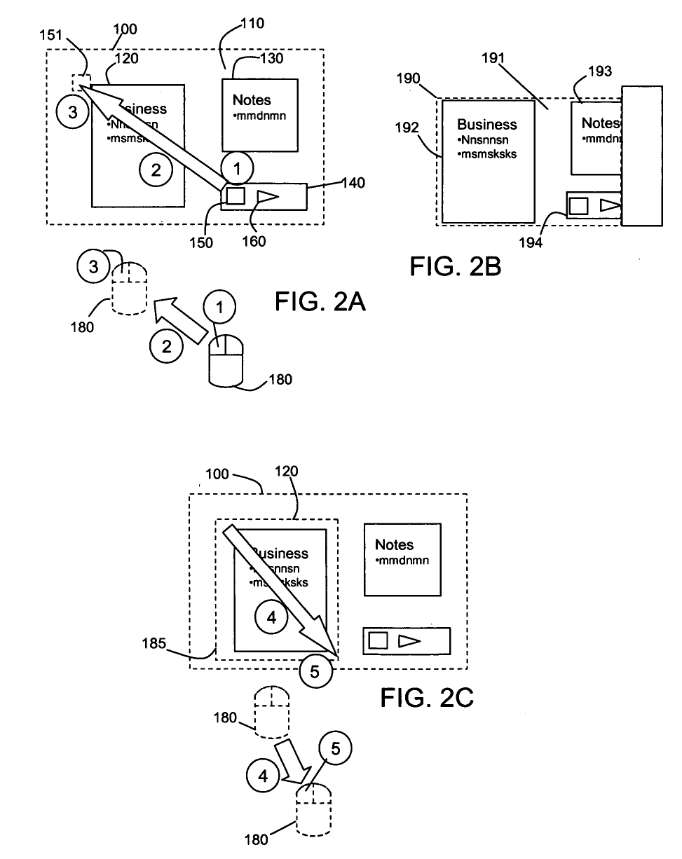

FIGS. 2A-2D illustrates various exemplary embodiments. FIG. 2A illustrates an electronic desktop 100 displayed on a monitor 110, which includes a display region 120 and a display region 130, and in this particular example a selectivity menu 140. The electronic desktop 100 may be, for example, displayed on the computer screen of a person giving a presentation from his computer (or from another type of electronic device). The electronic desktop 100 may include the presentation materials (e.g., an active window with a PowerPoint™ presentation) and other windows or applications running on the presenter's computer.

A corresponding display of a remote display 190 is illustrated in FIG. 2B. The electronic desktop 100 may be displayed on a first computer (the presenter's computer) which is running and displaying the output of one or more applications, while the remote display 190 may produce the display of a different, second computer which is not running the one or more applications but may be receiving signals from the first computer allowing the second computer to display any of the one or more applications. For example, the remote display 190 may be the display on remote monitor 191 (e.g., a computer screen) of a person viewing a presentation on their computer. The presentation may be the output of an application program running on the first computer (e.g., a PowerPoint™ presentation). The remote display 190 includes an active region of the monitor 191 (e.g., the monitor of a computer or other electronic device). The remote display 190 includes a projected display 192, a projected display 193, and a projected display of the selectivity menu 194. The remote display 190, may not be capable of containing the entire portion of the electronic desktop 100 (e.g. there may be fewer pixels in display 190 than in the electronic desktop 100). To illustrate this only a portion of projected display 193, and the projected display of the selectivity menu 194 is shown, for example, in FIGS. 2B and 2F.

The electronic desktop 100 is generally displayed on a single monitor of a computer, but may be spread across two monitors associated with one computer, for example, using the dual display mode of Windows™ (or another GUI-based OS). The remote display 190 is associated with a different computer. That is, the remote display 190 is not simply the second display of a dual display mode. By “spread across” it is meant that a portion of the electronic desktop 100 is displayed on one monitor while the remainder of the electronic desktop 100 is displayed on a different monitor.

An expanded selected region 185, as shown in FIG. 2C, may be designated in any of several manners known to those of ordinary skill in the art. For example, a GUI tool manipulated by a pointing device may be used. Such a GUI tool may be in the form of the selectivity menu 140 of FIG. 2A manipulated by interaction device 180. The selectivity menu 140 may include any number of menu items. In this particular example it includes two, menu item 150 and menu item 160. If one presses menu item 150, a selectivity tool (1) is toggled. The selectivity tool may be toggled and moved by use of an interaction device 180 (e.g. an input/output interface such as a mouse or a touchpad). The interaction device 180 can be moved (2) to move the selectivity tool to a beginning location, an unexpanded selected region 151. Optionally a second toggle (3) may anchor the beginning location.

As illustrated in FIG. 2C, the interaction device 180 may then be dragged (4) to an end location, in the process of expanding a shape or area on the electronic desktop 100 to delineate the expanded selected region 185 (FIG. 2C). Optionally a third toggle (5) may anchor the final position of the expanded selected region 185. After the final position has been selected the menu item corresponding to the “continue” or “play” button (e.g. menu item 160) may be toggled (6) to indicate the expanded selected region 185 as the active selected region 187 (FIG. 2D).

Once the a region becomes an active selected region 187 on the electronic desktop 100, signals may be sent (e.g., wirelessly transmitted) allowing remote display 190 to display only the active selected region 187 from the electronic desktop 100 but doesn't display other portions of the electronic desktop 100. For example, the remote display 190 does not display the display region 130 (e.g., Notes) because it is not part of the active selected region 187 from the electronic desktop 100. In this way, a first application (e.g., a PowerPoint™ presentation) may be sent from the electronic desktop 100 to be displayed on the remote display 190, while another portion of the desktop 100 (e.g., the PowerPoint™ notes not part of the presentation) may appear only on the desktop 100 and not on the remote display 190. The remaining portion of display C—that is, remote display 190 of FIG. 2B—may be the remaining portion of the active region of display 191. This remaining portion of remote display 190 may contain local programs or displays shown only on the display 190 but not on other remote displays or on the electronic desktop 100.

In at least one exemplary embodiment the expanded selected region 185 is chosen to be the excluded region, with the remaining portions of the electronic desktop being chosen as the content for remote display. For example FIG. 2F illustrates the exemplary embodiment where display 190 displays projected display region 193 and the projected selectivity menu 194, where the expanded selected region 185 has been chosen for exclusion from remote display.

Many variations of these methods are intended to lie within the scope of various exemplary embodiments, and the discussion with reference to FIGS. 2A-2F should not be interpreted to limit the steps or procedures to what is shown. For example, multiple portions may be selected for remote display (FIG. 2G), various portions of the electronic desktop may be selected for remote display (FIG. 2H), and the portions chosen for remote display may not encompass the complete extend of the remote display so that the remote display can run local programs and displays (e.g. client active display D 198) at the same time as the partially projected display 195, in the client active region 197 (FIG. 21).

In exemplary embodiments the contents chosen for remote display can change with time (e.g. a running program) and the changes can be likewise chosen for remote display. In at least one exemplary embodiment the contents chosen for remote display are automatically updated as changes occur and sent for display to the remote display.

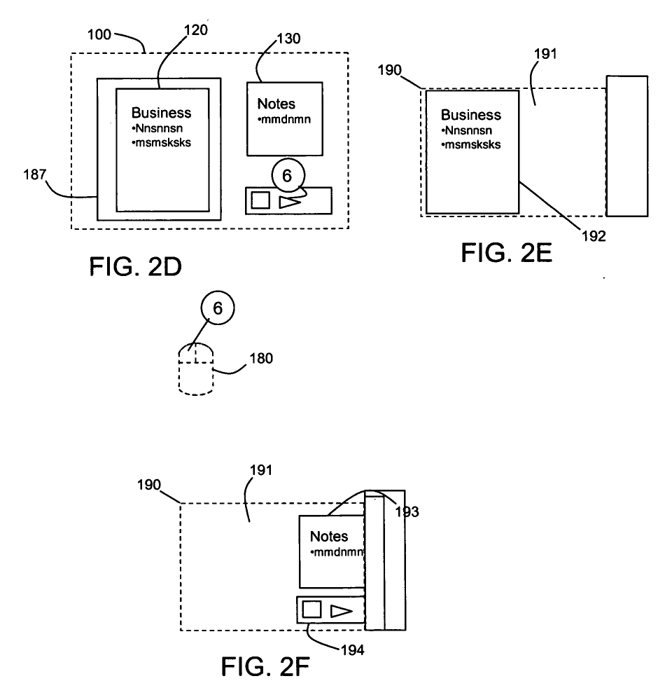

FIG. 3 illustrates a primary display device in accordance with at least one exemplary embodiment. The primary display device 300 includes the electronic desktop 310 controlled by an electronic desktop hardware support system 320 (e.g. computer, cellular phone, camera, video recorder, and other devices that one of ordinary skill would recognize as being capable of generating an electronic desktop). An electronic desktop could be the displayed region of many types of electronic devices, including, for example, a computer monitor, a cellular phone display, a notebook LCD display, a Palm Pilot™, Blackberry™, pager, and other display devices one of ordinary skill would recognize as being capable of providing a display.

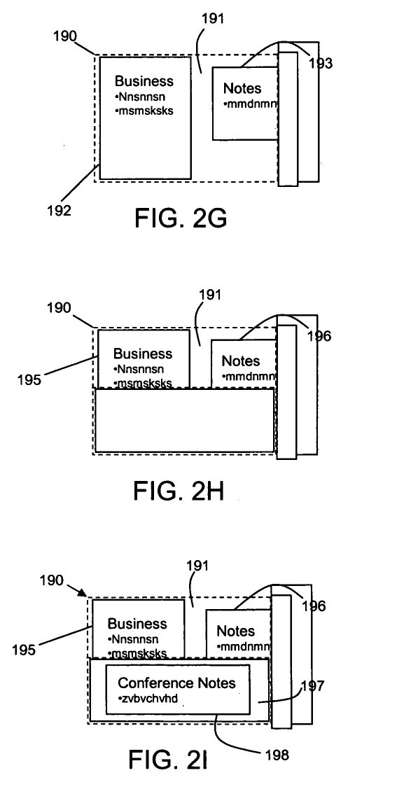

The electronic desktop hardware support system may include system memory that stores the data locations corresponding to the contents of the electronic desktop. The system memory may be partitioned to a portion that corresponds to the electronic desktop and a portion corresponding to expanded selected region. For example, FIG. 4 illustrates an electronic desktop hardware support system 400 in accordance with at least one exemplary embodiment. The electronic desktop hardware support system 400 may contain, as mentioned above, at least one system memory 410. The system memory 410 may contain a first portion 420 (A) of the system memory 410 associated with applications and displays in the electronic desktop as well as a second portion 430 (B) associated with applications and displays in the active selected region.

The contents of the various system memory portions 420 (A) and 430 (B) may be transmitted along a system bus 440 to a processing unit 450 (e.g. a processor), where the system bus 440 may be any bit sized bus (e.g. 32-bit, 64-bit, 128 bit). The processing unit 450 can separate contents corresponding to the transmitted portions A and B to various control units in the electronic desktop hardware support system 400. For example the processing unit 450 can separate and transmit the contents corresponding to transmitted portion A to a video adapter 460, which renders and displays the contents to a primary display 465. Likewise the processing unit 450 can separate and transmit the contents corresponding to the transmitted portion B to an interface unit 470, which transmits the contents of portion B to remote displays C1-CN 480.

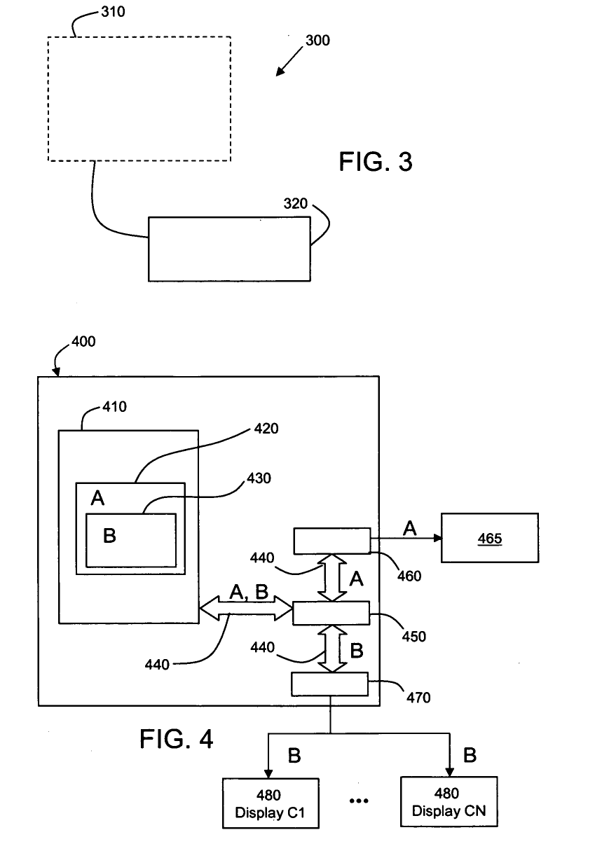

The process described above is summarized in accordance with at least one exemplary embodiment in the flowchart of FIG. 5. A method in accordance with at least one exemplary embodiment of selectivity 500 includes; selecting a portion of an electronic desktop 510; capturing the content of the portion selected 520; transmitting the content to a processor 530; where the content is distributed to a remote client 540; the remote client (e.g. a remote system including a remote display) receives and translates the content 550; then the client renders the translated content 560; and sends the rendered and translated content to the client's remote display 570. The remote display 570 may be operatively connected to a remote processor, where the remote processor is configured to receive the sent content of the portion selected (the send content). Likewise the remote processor may be configured to translate the send content. The remote processor may then render the translated send content, and display the translated and rendered send content on the remote display 570.

Various steps may be included or excluded as described above, with the remaining process still lying within the scope of at least one exemplary embodiment, for example at least one exemplary embodiment may include: providing an electronic desktop, where the electronic desktop includes a first portion and a second portion; selecting the first portion of the electronic desktop, where the contents of the first portion includes at least one of an application and a display within the first portion; determining a send content to be one of the contents of the first portion and the remaining contents of the electronic desktop, where the remaining contents of the electronic desktop is defined as the contents of the electronic desktop minus the contents of the first portion; and sending the send content to a remote display.

A processing unit used in any exemplary embodiment may be of any type that can perform the stated functions, for example a Pentium, RISC processor, or any other type of processor that one of ordinary skill would recognize as being useful for the steps stated. A processing unit in accordance with at least one exemplary embodiment can operate computer software programs stored (embodied) on computer-readable medium (e.g. hard disk, CD, flash memory, ram, or other computer readable medium as recognized by one of ordinary skill). The computer software programs can aid or perform the steps described above. For example computer programs in accordance with at least one exemplary embodiment may include: a source code for identifying a region in an electronic desktop, where the region is a portion of the electronic desktop; a source code relating the electronic desktop to a first stored data region on a data storage medium; a source code for relating the identified region to a second data region on the data storage medium; a source code for sending the contents of the identified region to a remote display; a source code for reacting to a user interface to identify a region; a source code configured for allowing and aiding a user to identify a plurality of regions to select a region; and a source code for sending the contents of the identified region(s) to a processor, where the processor sends the contents of the electronic desktop to a video adapter. There are many further source codes that may be written to perform the stated steps and procedures above, and these are intended to lie within the scope of exemplary embodiments. Many various protocols may be used as part of exemplary embodiments (e.g. to transfer content). For example, presentation/collaboration software (such as Sametime Connect and Netmeeting), remote desktop software (such as Microsoft RDC and VNC), and Xwindows for Unix/Linux, or other like programs or protocols known to those of ordinary skill in the art.

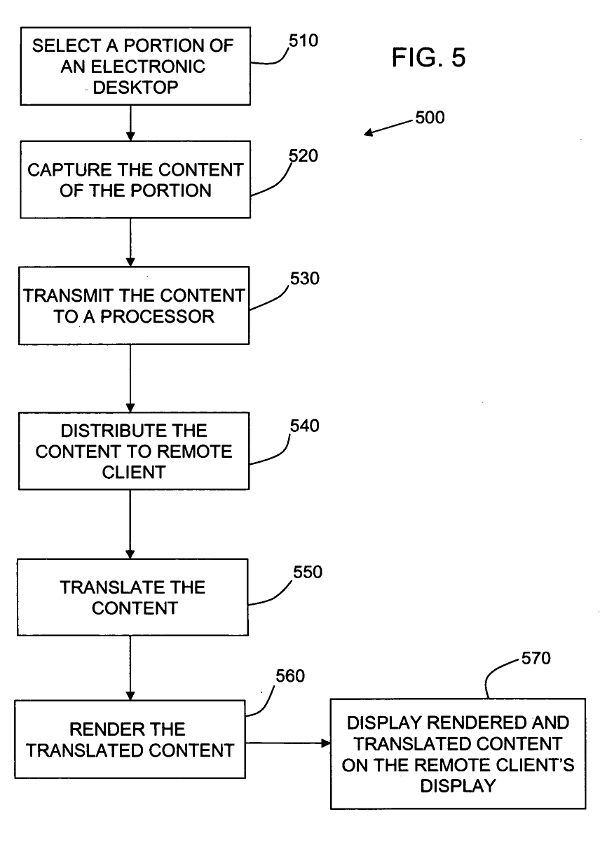

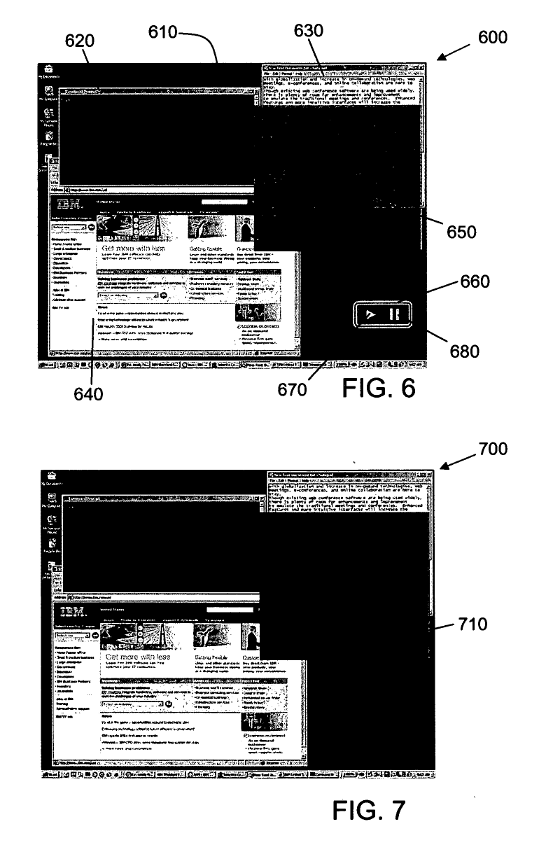

Examples of at least one exemplary embodiment of a primary display and a remote display are illustrated in FIGS. 6 and 7. FIG. 6 illustrates a primary display 600 including an electronic desktop 610. The electronic desktop 610 has an active region that may contain several software programs 620, 630, and 640. For example a display 640 is being shown with notes 630 in the upper right side of the electronic desktop 610. A user has selected a portion 650 of the electronic desktop 610 to obscure on a remote display. In at least one exemplary embodiment a pause button 680 on a selectivity menu 660 may be pressed to halt or freeze display to a remote display. Once the portion is selected 650, the play button 670 may be pressed to start transmission to the remote display. FIG. 7 illustrates the remote display 700, where the portion selected 650 has been blocked out 710. In other exemplary embodiments the selected portion may be selected to be the only portion to display remotely.

The description of the invention is merely exemplary in nature and, thus, variations that do not depart from the gist of the invention are intended to be within the scope of the embodiments of the present invention. Such variations are not to be regarded as a departure from the spirit and scope of the present invention.

What is claimed is:

1. A method for display selectivity comprising:
displaying an electronic desktop on a first electronic device, wherein the electronic desktop displays a first application output and a second application output;
selecting a first portion of the electronic desktop, wherein the first portion includes the first application output but not the second application output;
determining a send content to be the first portion of the electronic desktop; and
sending the send content to a second electronic device.

2. The method of claim 1, the sending further comprising:
wirelessly transmitting the send content to the second electronic device.

3. The method of claim 1, wherein the second electronic device displays the first application output but not the second application output.

4. The method of claim 3, wherein the second electronic device displays a third application output which is not displayed on the first electronic device.

5. The method of claim 1, wherein the selecting is performed with a pointing device.

6. The method of claim 5, wherein the pointing device is a mouse, the selecting further comprises:
moving the mouse to move a cursor to a start position on the electronic desktop; and
dragging the mouse to expand a shape on the electronic desktop, wherein the shape defines the first portion.

7. The method of clam 1, wherein the electronic desktop is spread across a first monitor and a second monitor using a dual display mode of a graphical user interface (GUI) operating system (OS), both the first and the second monitors being associated with the first electronic device; and
wherein a third monitor is associated with the second electronic device.

8. A computer readable media embodying a method for display selectivity, the method comprising:
displaying an electronic desktop on a first electronic device, wherein the electronic desktop displays a first application output and a second application output;
selecting a first portion of the electronic desktop, wherein the first portion includes the first application output but not the second application output;
determining a send content to be the first portion of the electronic desktop; and
sending the send content to a second electronic device.

9. The computer readable media as described in claim 8, the sending further comprising:
wirelessly transmitting the send content to the second electronic device.

10. The computer readable media as described in claim 8, wherein the second electronic device displays the first application output but not the second application output.

11. The computer readable media as described in claim 10, wherein the second electronic device displays a third application output which is not displayed on the first electronic device.

12. The computer readable media as described in claim 8, wherein the selecting is performed with a pointing device.

13. The computer readable media as described in claim 12, wherein the pointing device is a mouse, the selecting further comprises:
moving the mouse to move a cursor to a start position on the electronic desktop; and
dragging the mouse to expand a shape on the electronic desktop, wherein the shape defines the first portion.

14. The computer readable media as described in claim 8, wherein the electronic desktop is spread across a first monitor and a second monitor using a dual display mode of a graphical user interface (GUI) operating system (OS), both the first and the second monitors being associated with the first electronic device; and
wherein a third monitor is associated with the second electronic device.

15. A first electronic device, comprising:
a processor configured to operate using a graphical user interface (GUI) based operating system (OS) which displays an electronic desktop, wherein the GUI based OS runs at least a first application program and a second application program;
a memory configured to store the GUI based OS, the first application program and the second application program;
a monitor configured to display an electronic desktop including a first application output associated with the first application program and a second application output associated with the second application program; and
an input/output interface disposed to receive inputs for the GUI based OS to delineate a first portion of the electronic desktop which defines a send content, wherein the first portion includes the first application output but not the second application output;
wherein the processor controls the system to send the send content to a second electronic device.

16. The first electronic device as described in claim 15, further comprising:
means for wirelessly transmitting the send content to the second electronic device.

17. The first electronic device as described in claim 15, wherein the send content allows the second electronic device to display the first application output but not the second application output.

18. The first electronic device as described in claim 15, wherein the input/output interface a pointing device.

19. The first electronic device as described in claim 18, wherein the mouse is configured to move a cursor to form a shape on the electronic desktop, wherein the shape defines the first portion.
